(19) United States
(12) Patent Application Publication
(10) Pub. No.: US 2013/0198625 A1
(43) Pub. Date: Aug. 1, 2013

(54) System For Generating Haptic Feedback and Receiving User Inputs

(71) Applicants: Thomas G Anderson, Albuquerque, NM (US); Bill Anderson, Albuquerque, NM (US)

(72) Inventors: Thomas G Anderson, Albuquerque, NM (US); Bill Anderson, Albuquerque, NM (US)

(21) Appl. No.: 13/750,796

(22) Filed: Jan. 25, 2013

Related U.S. Application Data
(60) Provisional application No. 61/591,247, filed on Jan. 26, 2012.

(51) Int. Cl. G06F 3/01

(52) U.S. Cl. CPC G06F 3/016
USPC 715/701

(57) ABSTRACT

A system that can accept inputs from one or more users and that can give haptic feedback to one or more users. The system can utilize network communication of data, various complimentary types of end effectors, various complimentary methods for force generation, and various attachments and accessories.

### CROSS REFERENCE TO RELATED APPLICATIONS

This application claims priority to U.S. provisional application 61/591,247, filed Feb. 26, 2012, which is incorporated herein by reference.

### BACKGROUND OF THE INVENTION

The present invention is in the technical field of computer haptic technology. Haptics refers to the sense of touch. The present invention includes inputs into a system and system outputs for adding interactive multi-dimensional touch feedback to users through a mechanical, electrical, robotic, or other type of haptic device utilizing various end effectors, in conjunction with applications such as video playback, person to person interactions across a network, interactions with virtual characters or virtual objects, interactions with virtual environments, telerobotics, or other areas where a simulation of the sense of touch is desired. Interactions with haptic devices is a field that has been in existence for many decades. Many of the techniques utilized in haptic interactions, however, are still primitive in their implementation and ability to create realistic forces for a user both in hardware and software embodiments. Many current implementations of haptic devices and software are limited in how a user directly interacts with the haptic device as well. The present invention includes techniques that improve on existing haptic hardware and software embodiments to implement a system that gives users a more realistic sense of touch and a broader set of interaction techniques than has otherwise been possible. The present invention also includes complimentary hardware and software implementations that further improve a user's experience.

### SUMMARY OF THE INVENTION

The present invention is a system that can accept inputs from a user and can give touch feedback to a user. The present invention can include a number of components, or combinations of components, such as one or more haptic devices, end effectors for the haptic devices, computers or computational systems to control haptic devices, other inputs devices, computer networks, and electronic signals that activate the haptic devices. The electronic signals can be generated by a computer or other electronic system, and include any type of communication between computing devices. Electronic signals can be associated with or can originate from areas and content such as, without limitation, computer graphics data, computer simulations, virtual environments, video games, videos, entertainment, physical sensors, mechanical systems, other haptic devices, or interactions with other people or other computers or networks. The present invention can include the ability to attach one or more haptic end effectors to one or more haptic devices, which a user interacts with. Haptic devices can have differing end effectors for differing uses, can be grounded on a table or other stand, can be grounded on a user such as in the case of an exoskeleton, and can vary in mechanical form. The ways that a haptic device is actuated or controlled can vary depending on the application.

### BRIEF DESCRIPTION OF THE DRAWINGS

FIG. 1 is a block diagram of the process for haptic devices communicating across a network.

FIG. 2 shows exoskeleton haptic devices.

FIG. 3 shows a computation device connected to a display and a haptic device with an end effector.

FIG. 4 shows a lever arm connected to a haptic device which can rotate on a pivot point to support end effectors.

### DETAILED DESCRIPTION OF THE INVENTION

The present invention provides a system to receive inputs from users and simulate the sense of touch for users. It can include a haptic device that a user interacts with. A user's interactions can be implemented through an end effector or other type of physical interface that the user touches. For example, a user can hold onto an end effector that fits in one's hand which is physically attached to a robotic device that moves and creates user forces based on computer algorithms. A user can also interact with an end effector attached to a device in other ways, such as holding onto a representation of an instrument, inserting a body part into the end effector, or inserting the end effector into a user's body. End effectors can take any form. An end effector can be a simple geometric shape such as a sphere that a user can hold onto, a pen shaped stylus, a representation of an instrument, a representation of a tool, or a representation of a body part. End effectors can have electronic components on or inside them such as motors or memory. End effectors can also have sensors or interactive buttons on them. Sensors can indicate to the system an end effector's state, such as whether a body part is touching or inserted in an end effector, or if an end effector is inserted into a user's body. The term “haptic devices” (or simply “devices” when the context can include a haptic device) in this specification can include devices that give a sense of touch to a user or which move relative to a user, or it can also refer to robotic devices or other devices that are moved or controlled or devices through which forces can be applied to a user. Haptic devices can be exoskeletons. Haptic devices can be objects a user wears which give forces to a user where the object is worn. When a haptic device is described to be utilized as an input device, any other type of input can be utilized instead, such as a computer mouse, a joystick, a gamepad, voice controls, gesture recognition, a touchscreen, a camera, a body detection system, 3D cameras, or any other inputs known to those skilled in the art. Input devices can be haptic devices. When a haptic device is described in terms of its input capabilities, a non-haptic input device can be used instead. When an input device is implemented as a haptic device, feedback from communications of the system can be utilized to give forces to the user utilizing the haptic device as an input device. When a haptic device is controlled or actuated, which terms can be used interchangeably when the context is appropriate, the control or actuation can refer to any movements, vibrations, or forces from the haptic device, or any other type of haptic feedback to a user. Haptic devices can have any number of degrees of freedom such as devices that have only linear movement, devices that have planar movement, devices that have three dimensional movement, devices that have rotational degrees of freedom, devices that have other degrees of freedom implemented on an end effector, devices that have movement associated with joints or other anatomical features of a user, or devices that have any other number of degrees of freedom of movement. Many of the examples and embodiments described for the present invention are intended to work in conjunction with other examples and embodiments described, where the descriptions in the examples or embodiments can complement each other and are not mutually exclusive. Examples and embodiments of the present invention can be used with audio, video, smell, and taste data and sensory experiences, in addition to haptic data and experiences. Techniques utilized in portraying haptic data, storing haptic data, or transmitting haptic data can also be used for systems that present a sense of smell to users, or systems that present a sense of taste to a user, or systems that present senses of sight or sound to a user.

An example embodiment of the present invention includes a mechanical haptic device that moves and pushes against a user to create forces. The haptic device can receive electronic signals from a computer or electronic system which actuates the haptic device and creates the mechanical movements. For example, the haptic device can be moved by controlling electrical or other kinds of motors, piezoelectric actuators, pneumatic actuators, vibrating actuators, gyro actuators, magnetic actuators, exoskeleton joints, or in any other way that movement is created and presented to a user, or other ways that a haptic sensation is presented to a user. Movements that are described for haptic devices can refer to the device itself, portions of the device, points or sets of points related to the device, or an end effector of the device.

Network Communication of Haptic Data

An example embodiment of the present invention includes actuation of a haptic device that is implemented from electronic signals or data received from a network such as the Internet, a Local Area Network, a Wide Area Network, any other type of network, or any other situation where signals are sent from one computational system to another. For example, network communications can occur between computational devices or computers and haptic devices. Communications over networks should be understood to include any type of network communication, even those not described in a particular example or embodiment. Interactions that are described to occur over a network can also be implemented with other types of communications, including remote wireless transmission, cables that are long or short, or any other type of communication known to those skilled in the art. Examples and embodiments that are described to utilize a network do not need to be constrained to classic network communication techniques, and any type of data transfer can be utilized in these examples and embodiments as well. Examples that describe interactions with a human or user should not imply that those interactions have to be with a human. Examples can apply to control of a haptic device that is used for interactions with other objects whether real or virtual.

An example embodiment of the present invention includes actuation of a controlled haptic device or robotic device from electronic signals coming from a computer network, where the electronic signals are created from any type of input device such as a computer mouse or another haptic device. For example, the forwards and backwards movements of a computer mouse can move a controlled haptic device forwards and backwards, or those movements alternatively can move a haptic device up and down. Movements of a computer mouse can relate to movements of the haptic device such that there is a one to one correspondence of a degree of freedom of movement of the mouse to a degree of freedom of movement of the haptic device that is being controlled. The movements of the mouse can also correlate to the movements of the haptic device in other ways such as movements of a point on the haptic device along a plane in the device's workspace or any other mapping of movements. The point that is controlled can refer to a location in space in the software controlling the device or a specific point on the device, such as the center of an end effector, or a set of points. A haptic device can control another haptic device's movements or force generation, or they can both control each other's movements or force generation. Existing protocols like RTMP or specific new protocols or communication techniques can be created and utilized for transferring haptic and control signals. Data can be streamed, sent in packets, or transferred through any type of standard networking techniques. Data that is sent to a haptic device can include information such as position of a point on the haptic device, joint sensing, joint position, component sensing, or component position. Data can also include joint or component velocity, acceleration, button state, device state, sensor state, sensor data, or any other state information relating to the haptic device or controlling device. Movement of a controlled device can be a direct 1 to 1 movement of two similar devices, or it can be scaled from the controlling device to the controlled device. Movement of a controlled device can be delayed, reversed, or otherwise altered or transformed from the inputs of the controlling device. Any signals that are sent over a network can be translated into signals sent to a controlled device through algorithms or Application Programming Interfaces (API's) that control the device. Different devices in the system, such as in the case of two haptic devices controlling each other, can use different API's, for example.

An example embodiment of the present invention includes a haptic device that controls another haptic device. The movements of the controlling haptic device creates movements of the controlled haptic device over a computer network. The interactions of the controlled haptic device with objects or people creates resultant electronic signals that are sent back to the controlling haptic device, which are converted into forces felt by the user of the controlling haptic device. For example, if a user moves the controlling haptic device to the right, then the controlled haptic device can move to the right and bump into an object or push against another user. When the controlled haptic device bumps into an object or touches another user, then a signal can be sent to the user who is utilizing the controlling haptic device, making the bump into the object or other user felt. These interactions can create a perceived sense of touch and control, over a network. The devices can control each other as well, so that the movements of both devices control each other, and forces applied to each device can be felt by the other. There can be any number of controlling devices which send signals to any number of controlled devices. Signals sent to controlled devices can be added, averaged, or in any other way algorithmically modified to control a device from one or more controlling devices. Similarly, signals sent from a controlling device can be algorithmically modified to be utilized by one or more controlled devices.

An example embodiment of the present invention includes a controlling device, controlled by a first user, and any number of additional controlled devices that each moves and interacts with other users. The controlling device is a master device, and other devices controlled by the master device are slave devices. As the master device moves, all of the slave devices can receive signals over a network that cause them to move or create forces on users. Video of the first user can be sent from the first user to the other users as well through techniques known to those skilled in the art. The movements of the slave devices can be appropriately modified or delayed in their timing so that their movements match up with video of the first user. In this way the other users will perceive that their devices are being controlled by the first user. End effectors on the slave devices can interact with or push against the users of the controlled devices. A computer controlling the slave devices can be separate from the video display device or system. For example, video can be transmitted from a game console and the haptic device control can be implemented on a separate computer or on a separate haptic controller with a processor. Video can be transmitted on one computer and haptic device control can be implemented on a second computer.

Data sent from a master device can be echoed from a server or any other entity on a network in order to have electronic signals communicated to any number of slave devices. Data can be implemented or utilized depending on the state of an end effector (e.g. whether it is touching a user or not). For example, a medical professor at a university can present to students live video in a class, showing a medical needle injection procedure. As the professor moves the master device with a needle attachment, it can control other haptic devices in remote locations utilized by students participating in the class. The students in different locations can therefore see and feel the procedure as it is performed by the professor. A live presentation to a class can also be recorded, including data such as video data, audio data, haptic data, positional data, or any other data associated with the presentation, and can be played back later as well.

An example embodiment of the present invention includes an input device or haptic device that a user can control, that in turn can control a second haptic device that touches or pushes on the user. A third, or any other number of additional haptic devices, local or remote, can also be controlled by the first or second haptic device and interact with other users. This technique can give a user control over a haptic device touching or pushing on himself or herself, while also controlling haptic devices touching or pushing on other users. A primary user can utilize a first haptic device that controls a second haptic device that touches or pushes on the primary user. The use of the first haptic device can be implemented so that a sense of touch relating to the movements of the second device is felt by the user through the first device. The movements of either the first or second device can control a third device that touches or pushes on a second user. Additional users can utilize haptic devices that are controlled by the first, second or third devices. Video and audio and haptic data can be transmitted from the first user to the second user or other users. Video and audio and haptic data can be transmitted from the second user to the first user or other users. When a first user controls a device that in turn controls a second haptic device touching the first user, that control of the second device can be implemented locally, or it can be implemented from signals coming from other computers or devices that are remote, that received signals from the first device.

An example embodiment of the present invention includes multiple haptic devices utilized by users and network communications and data transfer between the haptic devices of multiple users. For example, a first user can hold onto the end effector of a first haptic device with a hand which controls a second haptic device touching a second user. There can be haptic feedback between the first and second devices. The second user can hold onto a third haptic device that controls a fourth haptic device touching the first user. There can be haptic feedback between the third and fourth devices. Other combinations of one or more users, each using one or more haptic devices where there is haptic feedback transmitted between the users, are possible. Any given haptic device can utilize an end effector intended to be held, or intended to touch the user other than the hand.

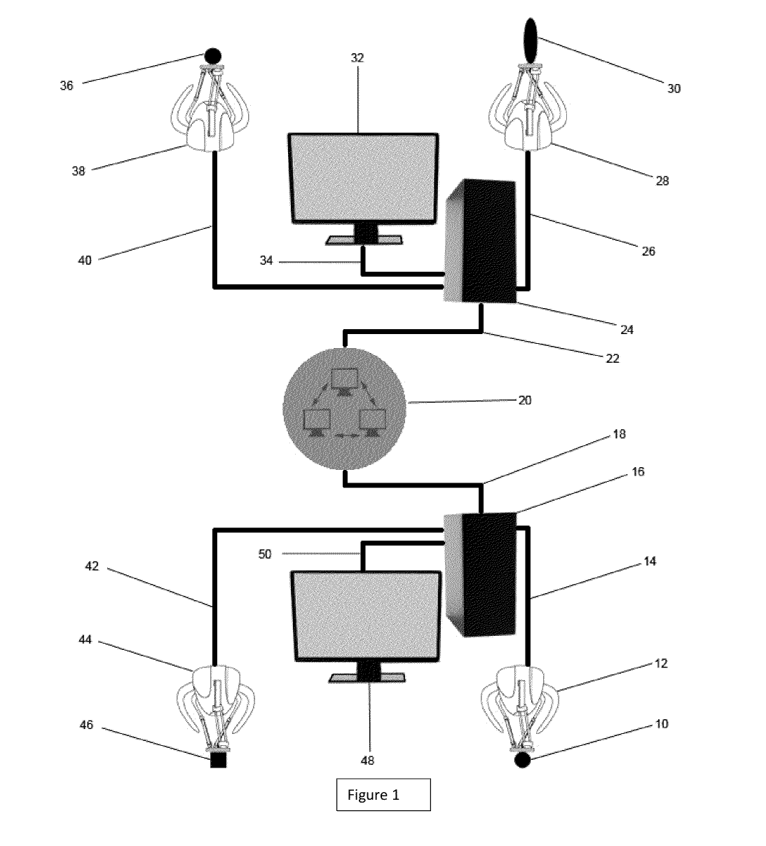

An example embodiment of the present invention is shown in FIG. 1. Haptic devices 12 and 44 are connected to box 16 through connections 14 and 42 respectively. Similarly, haptic devices 28 and 38 can be connected to box 24 through connections 26 and 40 respectively. Boxes 16 and 24 can be used to control, actuate, or receive inputs from a haptic device or other input devices or other output devices. Boxes 16 and 24 can be, without limitation, a personal computer, laptop, workstation, server, graphics processor, haptics processing unit, game console, video device, tablet, phone, portable computing device, or other computational electronic device. Connections 14, 18, 22, 26, 34, 40, 42 and 50 can be physical wired connections including USB, firewire, parallel port, VGA, DVI, HDMI, Ethernet, or any other standard or non-standard wired connection. These connections can also be wireless connections via Bluetooth, WiFi, Infrared, or other means of wirelessly transmitting data. End effectors, which can take any type of form or functionality such as 36, 30, 10, and 46 can be attached to a haptic device, or they can be part of a haptic device, or they and the connected device can simply represent an input controller or an output controller. Box 16 can be connected to a display 48 and box 24 can be connected to a display 32 to present visual and/or audio information to the user using each box and display. The displays may present information, data and events that are processed on either box 16 or 24, or data that is transmitted over network 20. Boxes 24 and 16 can be integrated into a display, into a haptic device, or into other components of the system. The displays can have built in cameras for sharing video and audio data across network 20. Boxes 16 and 24 can be connected to network 20, which can any type of network, such as a Local Area Network, Wide Area Network, Cloud network, the Internet or other type of network allowing computers and devices to communicate. A user can interact with haptic devices 38, 28, 44, or 12. These devices can simply be input devices as well, with no haptic feedback or output. These devices can simply move or transmit forces to a user without any input control. Any of these devices can interact with each other, and communicate data such as forces, inputs, and control. For example, a user can hold onto end effector 10 to move haptic device 12. This movement can be sent from the haptic device to box 16 via connection 14, across network 20 to box 24. Box 24 can process data to create signals for forces required to move device 28 to match the movement of device 12. The user in contact with end effector 30 can feel the forces resulting from the movement of device 28. The user in contact with end effector 30 can grasp end effector 36 to directly move end effector 46 through network communications in a similar manner. The system can include 1 or more haptic devices, input devices or output devices, connected to boxes such as 16 and 24. The system can include many boxes like 16 and 24, each with its own sets of input devices and output devices, so that, for example, many computers can communicate data with each other over a network. A local set of inputs and outputs connected to a network through connections 22 or 18, or example, can have the components shown, additional components added, or a subset of the components shown. A local set of inputs and outputs, for example, can simply consist of a simple input device like a mouse or a phone touch screen, which sends data to another system over the network. A local set of inputs and outputs can include many haptic devices. A local set of inputs and outputs does not necessarily require displays such as 48 or 32, for example.

An example embodiment of the present invention includes users who interact with haptic device who transmit data to other users, referred to as transmitting users. An internet or web application can allow many different additional users at different times and different locations to control a haptic device being used by a transmitting user. For example, users can log into a website, see potential transmitting users they want to interact with, and start an interaction session. Audio and video data can be sent from a transmitting user to other receiving users. Receiving users can utilize a haptic device or other input control to control a haptic device that moves or interacts with the transmitting user, seeing the device move through the video stream. The haptic device's interactions with the transmitting user or the transmitting user's environment can send data or signals back to the receiving user, and that data can be used by a haptic device used by the receiving user to create a sense of touch or haptic feedback. Data and signals from the receiving user's device can be sent back to the transmitting user's device, along with video and audio signals to make all of the interactions bi-directional where both users can see, hear, and feel each other. The web interface for the connection between transmitting users and receiving users can include a button that allows the purchase of a haptic device. The haptic device purchase button can take a user to a check out page, or it can be a simpler process that automatically takes a user's registered payment preferences, applies charges in currency or against credits, and transmits a user's shipping information to a shipper, such as through an order or a drop-ship purchase.

An example embodiment of the present invention includes a haptic device with a sensor or with an end effector that has a sensor, indicating state of the haptic device or end effector. Sensors can include things such as a light sensor, a motion sensor, a position or rotation sensor, an acceleration sensor, a velocity sensor, a magnetic field sensor, a pressure sensor, an electrostatic sensor, a force sensor, a biometric sensor, a temperature sensor, or other generally available sensor technologies. Sensors can be used to detect when a user is in contact with a haptic device or end effector, or if an end effector or haptic device is inserted on or in a user. Haptic control can be modified or enabled by sensor data. Sensor data can be utilized in conjunction with other inputs by users to modify control of inputs or control of outputs to or from users. Forces on a device can be interactively updated by network communications or from following a pre-programmed script of forces read from a file or database or any other method of storing the data. A user can modify pre-programmed playback by giving additional inputs, through the haptic device or through other input methods.

An example embodiment of the present invention includes a first user that controls a first haptic device. The first haptic device can control a second haptic device over a network that touches a second user. A sensor on the second haptic device can indicate the state of the second device with respect to the second user. Data from the sensor can be sent back to the first haptic device, adjusting the forces felt by the first user. For example, if the second haptic device comes in contact with the second user in a way that movement of the second haptic device would be constrained, the sensor on the second haptic device could indicate that situation. Forces and algorithms creating the forces on the first haptic device could be implemented or modified, so that the constraint in movement of the second haptic device creates a constraint on movement for the first haptic device. For example, if the second haptic device is a 3D haptic device, and interactions with the second user cause the 3D haptic device to primarily move along one axis, then movements of the first haptic device can be constrained to primarily move along one axis, or to be easiest to move along one axis. The constraint can be created algorithmically through an arbitrary algorithm rather than through control directly related to the teleoperation. These types of interactions can be bi-directional, so that both haptic devices modify each other, and sensors on each haptic device modify forces on the other. Multiple haptic devices used by multiple people can also utilize these techniques.

An example embodiment of the present invention includes interactions over a network between two users each utilizing one or more haptic devices. Haptic devices can control other haptic devices where movements and forces of one device controls another, or they can have bi-directional control where movements and forces for both devices creates movements and control for each other. Sensors can be utilized to give additional information to the system as to the state of the devices or the users. Haptic device movement can be modified by pre-programmed forces or movements. For example, two users each controlling a haptic device can connect their devices over a network, so that each device telerobotically controls the movements of the other, and so that forces applied to one device are felt by the other. Sensors can indicate that the users are physically interacting with their respective devices. When that state is determined, a pre-programmed movement for the devices can modify the telerobotic control and forces for one or both of the devices. The devices can start to vibrate, can start moving rhythmically, or can have their movements or forces modified in any other way. The user's movements and control of the devices can also adjust the pre-programmed movements. In this way, each user will feel a combination of the other user's movements and the pre-programmed forces and movements. Additional inputs, such as voice control or other handheld inputs, can further modify the pre-programmed movements, such as by adjusting the speed, magnitude, intensity, position, velocity, acceleration, or any other characteristic of the forces or movements.

An example embodiment of the present invention include body motion tracking, where a user's body position and movements are utilized as inputs into a system that transmits forces to the user or to other users. Body tracking technology can include exoskeletons, cameras or 3D cameras, infrared cameras, inertial sensors, acoustic sensors, magnetic sensors, or any other type of body tracking known to those skilled in the art. Body tracking can be used to modify or create inputs from a user into a system, and the resultant data and information can be utilized to control a haptic device. Motion of a user, for example, can control the motion of a remote haptic device. For example, the movement of an exoskeleton can track where a user moves his hand, and the 3D movements of the hand can control the forces and movements of a 3 DOF desktop haptic device. Cameras, including advanced camera systems such as Kinect, can also track movements of a user's body which can be used to control the movements of a haptic device or robot. These types of interactions can be used to directly control a haptic device, can control a haptic device over the internet, can control virtual representations of users such as avatars, or can control haptic devices through intermediate control of virtual representations such as avatars, as example implementations. Body motion tracking can be implemented through situations such as a live interaction, through streamed data, or through stored data. Motion tracking can be used in combination with audio, video, haptic, smell, and taste data to implement a system that includes sight, sound, touch, smell and taste sensory experiences.

An example embodiment of the present invention includes the separation of any haptic data from audio and video data. A common method for presenting information to a user is to combine sensory data into a single source. For example, DVD's include synchronized audio and video data. Webcam software and data streams often consist of synchronized audio and video data. Audio and video data, in most current forms of presentation, are combined into an existing format. It is often not feasible or desired to try and include haptic, smell, or taste data in conjunction with, integrated with, or co-located with the audio and video data. Haptic, smell, and taste data or data streams can be presented to a user through separate channels. A specific haptic server or set of servers on a network, for example, can be utilized to transmit haptic data to a user who is otherwise receiving synchronized audio and video information over the network. Haptic data servers can be connected into existing communication networks to add haptic touch support to existing infrastructures, or they can be utilized in parallel with existing communication networks. Haptic data can be synchronized with audio and video data whether it is pre-recorded or live. In a number of situations, there is no need to synchronize the haptic data, such as when there is direct telerobotic control between haptic devices and synchronization with audio and video data does not necessarily add value. In other situations, such as when there is pre-recorded data and a haptic device is intended to present forces that are synchronized with the audio and video data, a synchronization method can be used. The audio or video data or both can include timing triggers that can be recognized by a computational system which in turn controls a haptic device. For example a specific video pixel change or specific screen or audio indication can indicate when a pre-recorded haptic set of data should begin playing. A computer or computational system attached to a haptic device can begin an audio and video playback, eliminating the need for any data to be included in the audio and video data, and where there is no control coming from the audio and video data or a controller playing the audio and video data.

An example embodiment of the present invention includes haptic servers where data is transferred from one haptic device to another or where data is transferred from a user controlled input to a haptic device. The haptic servers can be separate from video and audio servers, and the haptic data streams can be separate from video and audio data streams. Electronic signals can be sent from an input device to the server. The signals in turn can control or enable a haptic device. The haptic server can include or have access to account information for users who want to use a haptic device over a network. Users can be required to log in and verify valid account status before a haptic device can be enabled. For example, a user with a first haptic device watching a live feed of a video stream, where another user originating the video stream has a second haptic device, can log into a haptic server to control the second user's haptic device, and feel the interactions with the second user's haptic device and the second user or the second haptic device and its environment. The control and activation from the first haptic device can be disabled, or not enabled, if the user is unable to properly log in, the account status doesn't allow particular functionality, or if there is a problem with account status, for example. The log in process can include, without limitation, things such as account verification, password or other security verification, payment or payment status verification, haptic device identification, payment means, identification means, indication of which other haptic device or devices are desired to be connected to, identification of which other users are desired to interact with. Payment can be required for the use of an input or haptic device to utilize the haptic server, and therefore interact with other haptic devices. A specific communication protocol can be implemented that must be used in order to communicate with a haptic device. For example, a hardware chip that decodes signals from a USB port on a computer can require a specific type of signal in order to allow a computer to communicate with the haptic device. A haptic server can either require that the specific communication protocol be used or require that the computer connected to the haptic device utilize the communication protocol, in order for a haptic device to be enabled to work. The communication protocol can also be specifically communicated through a haptic server.

An example embodiment of the present invention includes controls to provide network stability and device stability for haptic device communication across a network. Position and state information can be sent from a master device across a network to a slave device, where the master device controls or modifies the movement of the slave device. For example, a slave device can move to match the direct or proportional movement of a master device. A slave device can communicate state information back to the master device to control and update the forces felt by the user controlling the master device. An application running on the computer connected to the master device can process the state information sent by the slave device and generate forces for the master device. Limitations on the input of the master device or movement and forces applied to the slave device can give stability to the controls, particularly when there is lag in the network communications. Information provided to the slave system can also include information that is innately controlled to maintain stability. For example, the slave system can move an end effector to a point defined by the master system. The master system can directly control the point's movements, but a control system can modify the master's control so that the point cannot move too quickly, for example. Each device can be a slave to the other utilizing the same techniques, so that the control and forces are bidirectional and stable.

An exoskeleton can be used to control another exoskeleton or another haptic device. Stability in the control can be implemented in a way that forces are applied to joints to guide movements or prevent unwanted movements in the control. Similarly, forces in a controlled exoskeleton can be implemented to guide movements or prevent unwanted movements.

An example embodiment of the present invention includes a master device with an end effector that controls a slave device. A user can hold onto the end effector of the master device to control the movement of an end effector on the slave device. The end effector on the master device can be correlated with the end effector on the slave device. For example, the master device can have a scalpel end effector, and the slave device can have a scalpel blade. The end effector on the slave device can have sensors that modify the interactions between the master and the slave. For example, a scalpel blade end effector can have a force sensor that is triggered when the blade presses against something. This type of feedback can be used to create a force that the user of the master device feels. For example, a scalpel blade end effector touching tissue below it can create an upwards force for the user, proportional to the amount of force the force sensor detects. The user of the master device can manipulate the master device to control the slave for any type of purpose such as cutting tissue in a surgery, or touching another user. A master and slave configuration can include related end effectors for simulating virtual or remote sex.

An example embodiment of the present invention includes an audio and video system that is largely or completely separated from a haptic system. The audio and video system can transmit audio and video over a network from one user to another, such as through a mobile phone equipped with a camera. A haptic communication system can be utilized where inputs from one user or inputs into a haptic device control or modify the movements and forces presented to another user on a second haptic device. The haptic devices can communicate over a network completely separate from the audio/video network. For example, audio/video communications can occur over a phone network and the haptic communications can occur over the internet, or the audio, video, or haptic streams can occur over different communication streams or methods over the internet.

An example embodiment of the present invention includes an exoskeleton controller which users wear over a portion of their bodies, which gives users a sense of touch. The forces for an exoskeleton controller can, without limitation, be driven through communications over a network, can be driven through interactions with video and audio data, or can be driven through interactions with a virtual world, as examples. A user can place an exoskeleton over a body part, and joints in the exoskeleton can match up with joints on the user. For example, an exoskeleton that fits over a user's arms can have joints that match up with a user's shoulder joints, elbow joints, wrist joints, or finger joints. An exoskeleton that fits over a user's leg can have joints that match up with hip joints, knee joints, ankle joints or toe joints. An exoskeleton that fits on a user's shoulders can have joints that match up with shoulders or the neck. Any joint on a user can have a matching joint on an exoskeleton. Multiple exoskeletons can be used, such as an exoskeleton on each arm, an exoskeleton on an arm and a leg, or any other combination. The movements of the joints in an exoskeleton can be tracked so that the movements are utilized to represent a user's movements in a computational system. Movements can be tracked as inputs into a telerobotic control system, control of an avatar, control of another user's haptic device or exoskeleton, or control of a virtual environment, as examples. Motors or other types of actuation can create forces that are sent to a user's joints or skin through movements or forces of exoskeleton components and joints. A cable driven system, for example can create a force at an elbow joint creating the feeling that the user is holding a virtual object with weight. Motors directly attached to joints or attached through other transmission mechanisms can create joint or skin forces as well.

An exoskeleton can be used to control another exoskeleton. Movements or forces from a first exoskeleton can be transmitted to a second exoskeleton. For example a first user wearing a first exoskeleton can move the exoskeleton. Movements or forces of the first exoskeleton can be tracked. Data from the tracked movements or forces can be sent to a second exoskeleton worn by a second user, to create movement and forces for the second exoskeleton. A second user can feel the movements of the first user.

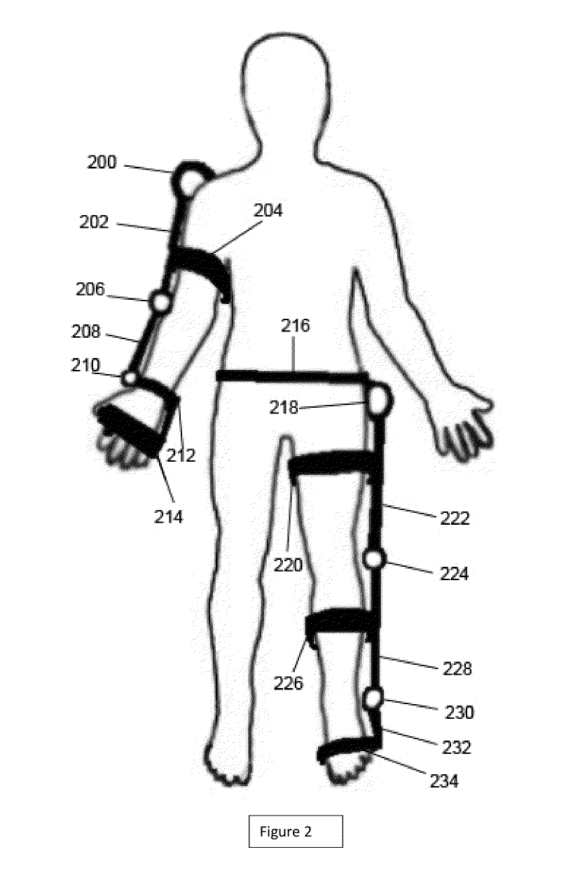

An example embodiment of the present invention is shown in FIG. 2. FIG. 2 shows an arm and leg exoskeleton haptic device. Joint 200 of the arm exoskeleton aligns and can rotate with movement of the users shoulder. It can also present forces to a user at that joint. Joint 206 aligns and can rotate with movement of the user's elbow, and can present forces at that joint. Joint 210 aligns and can rotate with movement of the users wrist, and can present forces at that joint. Connections 204 and 212 help hold the exoskeleton to the user's body to maintain proper alignment and transmit force feedback or haptic feedback. These connections can be made of flexible fabric or other material or can be more rigid in structure of adjustable plastic or metal that can be adjusted to allow the users to insert his or her arm into the exoskeleton, tighten the connections comfortably, and loosen the connections to be able to remove his or her arm from the exoskeleton. Supports 202 and 208 hold the exoskeleton structure together and connect the moveable joints of the exoskeleton. These supports can be rigid in nature of plastic or metal construction, or can have some flexibility in their material makeup. With the user's arm inserted into the exoskeleton, the user can hold onto end effector 214 which can be detached and replaced with other end effectors. The end effector can have any of the properties described throughout the specification of the present invention for any haptic device end effector. A user can move his or her arm with full range of motion of his or her physiological joints while wearing the exoskeleton. That motion or any subset of the motion can be tracked by a computational device communicating with the exoskeleton. A computational device can communicate wirelessly, can be attached to or part of the exoskeleton, or can be connected by a wire, as examples. Similar to the arm exoskeleton, for the leg exoskeleton connections 216, 220, 226, and 234 connect the device to the user's body, and supports 222, 228, and 232 provide support and structure for the leg exoskeleton. Joint 218 of the leg exoskeleton aligns and can rotate with movement of the users hip and can present forces at that joint. Joint 224 of the leg exoskeleton aligns and can rotate with movement of the user's knee and can present forces at that joint. Joint 230 of the leg exoskeleton aligns and can rotate with movement of the user's ankle and can present forces at that joint. Joints 200, 206, 210, 218, 224, and 230, or any other joint in other types of exoskeleton controllers, can all have various means of detecting motion, providing power, or generating forces to the user. Forces applied to the joints can be used for purposes such as guiding a user's movements, creating forces simulating interactions with a virtual environment or virtual objects, or simulating interactions and a sense of touch with other users. Each joint can have sensors that detect data such as motion, velocity, acceleration or pressure through the use sensor components like encoders, potentiometers, accelerometers, gyros, strain gauges, force sensors, or any other sensor that can be used to detect user input. Each joint or communications to or from the joint, can be actuated with batteries, can contain wired or wireless communication components, or can contain other electronics that aid in the movement detection and tracking, operation, and force generation of an exoskeleton. Each joint can have various force generation capabilities such as using DC servo motors, geared motors, breaking systems, vibration motors, clamps, springs, or any other general means of providing adjustable resistance or force feedback or haptic feedback to the user.

An exoskeleton can be used in conjunction with other haptic devices. An exoskeleton's movements can control a desktop device's haptic movements, for example. As the user moves a body part within an exoskeleton, those movements can control the movement of a robotic arm or a haptic arm. Sensors on a controlled haptic device or on its end effector can be utilized to transmit signals back to the exoskeleton, so that a sense of touch is created for the exoskeleton user. For example, if a controlled haptic device end effector touches an object, then the exoskeleton can be actuated so that the forces related to the touching are felt.

An exoskeleton can be used to control an avatar or virtual representation of a user. For example, the movements of an exoskeleton over a user's arm can be used to control the arm of an avatar in a virtual environment. An avatar's interactions with a virtual environment can send data back to a user with an exoskeleton, to create forces and movements simulating a sense of touch for the user controlling the avatar. For example, if a user moves an arm, which makes an avatar move its arm and the avatar's arm touches something in the virtual environment, then signals representing that touch and forces involved with the touch can be sent back to an exoskeleton to actuate it, giving the user the sensation that he or she actually touched the object. In this way, a user can both control an avatar, and feel what the avatar feels. A first user controlling a first avatar with a first exoskeleton can interact with a second avatar controlled by a second user using a second haptic device. The first avatar can touch the second avatar, and feel the interactions through the first exoskeleton. The second user can also feel the interactions through the second haptic device. The second haptic device can be an exoskeleton or can be a haptic device that interacts with a user through an end effector that the user hold or that touches the users body other than his or her hand.

Force Generation

An example embodiment of the present invention includes haptic devices that can create forces or movements sensed by a user. The forces and movements that the haptic devices create can be implemented in a variety of ways. Forces and movements can be created by inputs and control from another haptic device or input from a user. Forces and movements can be created programmatically or algorithmically. Forces and movements can be created from interactions with virtual environments. Forces and movements of a haptic device, whether moved directly or moved through other types of control like teleoperation, can be recorded and then later replayed on the haptic device or on other haptic devices through saved data in a file. Data can include position information, state information, velocity information, acceleration information, force information, sensor information, or any other information relevant to the forces that a user will feel.

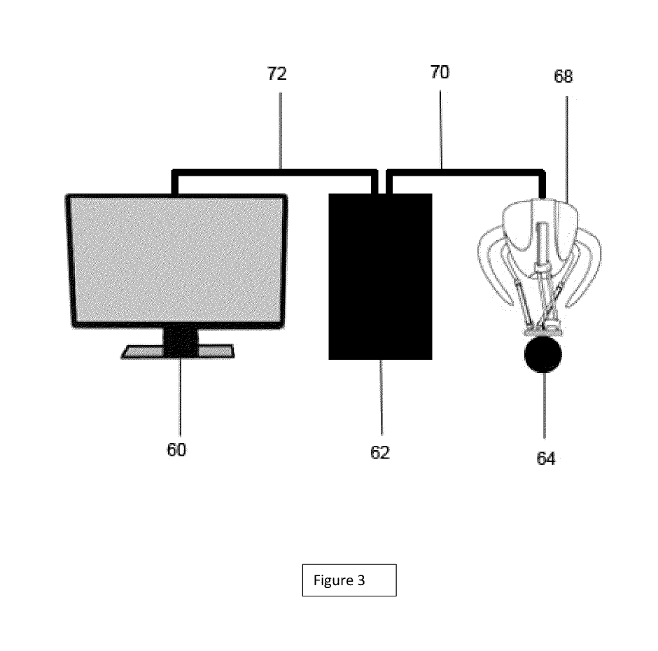

An example embodiment of the present invention is shown in FIG. 3. Haptic device 68 can be connected to box 62 through connection 70. End effector 64 can be connected to haptic device 68 and can be removable and interchangeable with other end effectors. End effector 64 can be permanently attached or a component of haptic device 68. Box 62 can be a personal computer, laptop, workstation, server, graphics processor, haptics processing unit, tablet, phone, portable computing device, game console, video processing device, or other computational electronic device. Box 60 can be incorporated into display 60 or into haptic device 68, as examples. A haptic device, computational device, and display can all be combined into a single unit. Connections 70 and 72 can be physical wired connections including USB, firewire, parallel port, VGA, DVI, HDMI, Ethernet, or any other standard or non-standard wired connection. These connections can also be wireless connections via Bluetooth, WiFi, Infrared, or other means of wirelessly transmitting data. Box 62 can be connected to display 60. Display 60 can be used to present visual and/or audio information to a user. As a user watches display 60, box 62 can process haptic information which can result in haptic device 68 transmitting forces or movements to a user. The user can holds on to end effector 64, touch end effector 64 other than through a hand, insert a body part into end effector 64, or inserts end effector 64 into his or her body to feel the forces or movements generated.

Forces and movements of an exoskeleton can be used to control a user's movements and to create haptic sensations for the user. Recorded movements and forces of an exoskeleton can be used by another user wearing the exoskeleton or wearing a different exoskeleton to simulate one person's movement for another person. Movements of dancing can be recorded, and then users can feel those recorded movements to learn how to dance. Forces can be applied to joints of an exoskeleton to keep a user within correct movements, or forces can be added or removed when a user is doing an incorrect movement. Movements of a golf swing or any other sports activity can be replayed for users so that they can learn a correct swing. Users can also learn what it feels like to move as a celebrity would move such as the swing of a famous golfer. Recorded movements of people having sex can be replayed later by users wearing an exoskeleton who want to feel what the people were feeling and doing, and feel how they were moving.

Forces and movements of a haptic device can be controlled, without limitation, from another haptic device with the same degrees of freedom, a device, haptic or only input, with different degrees of freedom and a mapping of the degrees of freedom from the controlling device to the controlled device, a computer mouse, keyboard, mind control, electromagnetic wave detection, voice commands or control, frequency control, sound or music, gestures, camera tracking, acoustic tracking, magnetic field tracking, infrared tracking, acceleration tracking, or any other inputs known by those skilled in the art.

An example embodiment of the present invention includes a system that records the movement of a haptic device for later playback. A user can indicate that a recording session should start. The user can then move the haptic device either directly by holding onto an end effector of the device or through some other type of control. Data relating to the movement of the haptic device can be saved into a file. Later, the file can be used to recreate the movement of the haptic device. This movement and recording can be implemented in a way that the movements are synchronized with audio and video information. For example, audio and video information can be played at the same time that the user records the device's movements. Later, the same video and/or audio can be played and synchronized with the haptic device's movements. Any type of grip interacting with the user and creating forces or sensations that the user can feel can be utilized when the audio, video, and haptic data are replayed to give users the feeling that they are interacting with the video. A haptic control system can be utilized that includes haptic data that is separate from the audio and video data. The haptic control system can indicate when audio and video data should begin playing, so that there is no need for any haptic information or for very little haptic information to be included or related to the audio and video data. The haptic control system can therefore control the haptic playback, and can time the beginning of the audio and video data playback beginning point so that the haptic playback is synchronized with the audio and video playback. Haptic playback can include the ability to time shift the haptic playback to match video playback. This time shift can be implemented by queues from the audio or video data, by processing and interpretation of the audio and video data, or by an external mechanism that starts any of the data streams at the appropriate time. Time shifts, time scaling, magnitude scaling, or any other effects for any of the data streams can be applied at the time of recording, after recording, or during video/audio/haptic file playback. During recording of data, both video playback and haptic force recording can be time scaled to allow for a more accurate synchronization of the haptic device's movements and forces to the video. This allows a video to be played at a slower or faster rate, which can be adjusted by a user, and as the haptic device information is recorded, the time shift is accounted for in the recorded data so that during playback the video and haptic movements match. Movements that are detected by a haptic device or other input device can be used to control the playback of video. It can be used to control the speed or sequencing of playback, as examples.

Video can be monitored or processed to modify or create haptic interactions. Video played at a faster speed or faster movements in a video by a person on screen, can make a haptic device's feedback faster in its motion, as an example.

Haptic device forces and movements can be recorded at the same time as audio and video data. A performer who is being recorded can have sensors which record his or her movements, which can create data and information that is later utilized to move a haptic device or create forces for it. The haptic device can be a device that is grounded separate from a user, for example, or it can be an exoskeleton with forces grounded against other parts of the user's body, or it can be an exoskeleton that is grounded separately from the user. The performer can interact with a haptic device, creating haptic data that is recorded, while audio and video data are recorded at the same time. The haptic, audio, and video data can be stored together or they can be stored separately. A haptic device can be controlled by a computer that is different from a video device or audio device. For example, video and audio data can be played by a computer, game console, a set top box, or other AV transmission equipment, and the haptics can be controlled by a separate computer.

A collection or set of haptic interactions can be recorded or generated, and then later specific elements of the set can be utilized in conjunction with audio and video data. Individual elements of the set can be determined to be played back in conjunction with audio and video data. Elements of the set can be synchronized with audio or video data, or they can be played independently of any audio or video data, or without any audio or video data. Pre-recorded haptic data can be created by sensing physical interactions of real life objects, simulating physical interactions through physics algorithms, or through approximations of the physics involved to create approximate forces comparable to the physics interaction being simulated.

Sensors on a haptic device or on a physical object can record forces applied to those sensors. For example, a haptic device can be used to move a sensed object across a surface, recording data associated with the movements and touching of the object across the surface. The data can be analyzed and interpreted to recreate the forces in another haptic device. For example, a frequency analysis of the data, such as a Fourier analysis, can be used to implement a Fourier representation of those forces when a haptic device is sliding across a virtual surface that is intended to feel similar to the recorded surface. This can be used to simulate a surface texture such as cloth, fabric, skin, or sandpaper, as examples. There are many types of forces that can be simulated or recorded. Without limitation, examples include the simulation or recording of an explosion or a fire, a surface texture, an impact, a movement or motion, a gun recoil, surface contact, a release of energy, human contact, a vehicle's movements or forces, an impact or force applied to a human body, object dynamics or motion, object weights or accelerations, or any other forces applied to any other object. Forces that are recorded can be applied to joints in an exoskeleton as a representation of the forces a user's joints would feel, through haptic interaction with the skin representing forces a user would feel through their skin, through a Jacobian transform applied to the movements of a haptic device, or in other algorithms simulating the forces in a haptic device.

Forces can be recorded on a haptic device itself or end effector to later be implemented on the haptic device or another similar to it, or they can be recorded in a completely separate medium where an algorithm changes forces from the sensor data to a particular haptic device. For example, the impact of a ball hitting a bat can be sensed on the bat, and the forces that were sensed that were applied to the bat can later be applied to an exoskeleton being used to implement a user holding a virtual bat. Measurements of forces on a sexually stimulating device such as a dildo or on a human body part during a sexual act can be recorded. The forces can include forces applied in order to create movement, or forces pressing on the sexually stimulating device or human body part while it is used. The recorded forces and movements can be applied to a sexually stimulating device such as a dildo controlled by a haptic device to simulate the feel of the recorded interactions, or the forces can be applied to a counterpart sexually stimulating device, such as a male sexually stimulating device, to simulate the forces involved in the counterpart experience. Forces can be recorded from user's direct movements as well. Sensors placed on a person to be recorded can sense the movements and forces of any type of human interaction such as, without limitation, a chef's hands preparing a meal, a baker's hands kneading dough, human contact, a masseuse's massage, a surgeon's use of a medical instrument, a gymnast performing a backflip, a soccer player heading or kicking a ball, or a basketball player's shot of a basketball. The recorded forces can be used to recreate the act itself, letting other users feel what the person doing the action did such as feeling the haptic sensations of preparing a meal, kneading dough, touching another person, massaging, using a medical instrument, performing a backflip, heading or kicking a ball, or shooting a basketball. The recorded forces can also be used to recreate the result of the act, such as being operated on, being touched, receiving a massage, or being kicked. Forces can be applied to a handheld device simulating recorded forces, or a haptic device or end effector can be applied to parts of a user's body other than the hands to simulate the forces.

An example embodiment of the present invention includes interactions between a user and a haptic device, where the user is watching a video and where the haptic interactions are intended to compliment or accompany the video. The haptic device can push on, interact with, or present forces or vibrations to the user. The user can also control movements for the haptic device, or forces on the haptic device. The user's control or forces on the haptic device can adjust how the video is played. Movements of the device can adjust the video's playback speed, for example. Interactions and inputs into the system can adjust which videos are played in which sequence, and videos that are played can present to the user haptic feedback related to any of the videos being played.

An example embodiment of the present invention includes haptic force feedback information or haptic device movement information, where the information is stored in the same location as video and audio information. Haptic information can be encoded into video or audio data, added to audio or video data, or combined with audio or video data. The combined haptic, audio, and video data can be located in the same location or transmitted in the same way. For example, the audio, video, and haptic data can be located together on a physical medium or data storage implementation, or the various data can be streamed over a network such that the various sensory data information is transmitted together. For example, packets of information transmitted over a network can include audio, haptic, and video data.

An example embodiment of the present invention includes a set of recorded movements or forces for a haptic device where the recorded movements or forces can be played back later, moving the haptic device or creating forces for the haptic device. The set of recorded movements or forces can be a preferred set of movements or forces. The forces or movements can be applied to other users or other devices or they can be applied to the original user. For example, if a surgeon performs a medical procedure with a haptic device, the movements and forces created during the procedure can be stored as a successful implementation of the medical procedure. These movements and forces can later be played back to medical students who want to learn the medical procedure. Preferred sets of movements and forces can be utilized with sexually stimulating devices. A set of movements that effectively sexually stimulates a user can be recorded and played back later or can be shared with other users. Haptic settings that are saved can represent a specific celebrity such as a famous surgeon, a specific model or movie star, or a famous athlete. Preferred sets of movements can be stored for later playback or they can be streamed through selections coming from one or more live broadcasts.

Preferred sets of movements and forces can include forces and movements created by a celebrity or someone popular or famous in their field. For example, movements of a famous race driver moving a haptic steering wheel can be recorded, and other users can feel his movements or forces, and get a sense of how he performs on a specific track. Forces or movements of a celebrity chef can be played back later to people who want to learn how to cook or prepare food. Movements of a popular film star can be recorded and later played back in order to give a user utilizing the recorded movements a sense of intimacy with the star or a recreation of a sexual experience with the star. The swing of a professional golfer can be recorded and can be used to guide golfers who want to improve their swing. Many other examples of forces recorded to be played back later exist, and include any situation where there is value to recording forces or movements that are later played back for a user or other users.

An example embodiment of the present invention includes integration with social media, where the integration with the social media allows users to share data associated with a haptic device. A user can join a community or website, upload data associated with a haptic device, and indicate that the data should be shared. Data that can be shared can include, without limitation, data such as movements of a haptic device related to audio or video, preferred sets of haptic movements or forces, sales information relating to the sale or promotion of haptic devices, end effectors, accessories, or other items related to the haptic devices.

An example embodiment of the present invention includes adjustments to forces and movements with a haptic device to create a difference in perception of a situation. Adjustments to the haptic interactions, for example, can be applied to a simulation or as adjustments to telerobotic control of a haptic device. A haptic interaction simulating preparing food or telerobotically preparing food can be adjusted so that the food feels fresher or not, depending on how much force is needed for particular cooking interactions like chopping. Haptic simulation of sexual experiences can vary depending on the type of experience desired to be presented to a user. Movement representing a sexual experience can be modified to further express variation on the sexual experience. For example, a movement representing intercourse can be modified so that movements are easier to represent a state of sexual arousal. Settings and modifications can also represent a specific actress or model, and can be marketed as such. Measurements of a specific person can be recorded and applied to a haptic simulation. A recording of a specific person's sexual experience can be recorded and played back later to simulate a sexual experience with that person. Adjustments of a haptic simulation or telerobotic interaction can represent a specific partner's characteristics in a sexual representation, such as body size or characteristics, age, body definition or fitness, body function or arousal level or state, or race. The amount of variation or modification to haptic forces can vary throughout a simulation, such as to simulate an increase in arousal level. A haptic interaction simulating a medical procedure or telerobotically controlling a medical procedure can be adjusted so that there is the perception of a complication or not. For example, in a medical simulation, the injection of a needle where the needle hits bone instead of a desired tissue layer can resist movement more. In a telerobotic medical procedure, a sensor on a needle actually being injected into a patient can sense a denser material indicating a potential tumor, and a vibration can be added to the forces being felt to indicate that specific sensor reading.

Haptic forces, movements, and adjustments to forces and movements can be utilized to simulate any type of experience where a sense of touch is desired. Haptic forces, movements, and adjustments to forces and movements can be utilized to teach users the best way to perform an action. For example, a simulation of a medical procedure can teach medical students how to perform the medical procedure, a simulation of a sexual act can teach a user how to best create a sense of pleasure in a partner, or a simulation of building something mechanical can teach a worker how to build the item.

An example embodiment of the present invention includes haptic interactions between users and virtual representations of humans, or avatars. An avatar can be any type of representation of a human in a virtual environment or an augmented reality environment. For example, an avatar can be a 3D representation of a human in a virtual environment. An avatar can represent a full body of a human or user, a part or body part of a human or user, or a representation related to a human or user. A haptic device can be utilized to control objects that interact with avatars, control avatars themselves, control avatar body parts, control avatar joints, or in other ways interact with avatars through a virtual representation of an object controlled by a haptic device. Interactions with an avatar by a user can be related to an avatar that represents the user himself or herself, or can be related to an avatar controlled by another user or controlled by artificial intelligence. Forces and movements can be applied to a haptic device based on interactions with an avatar. For example, if a user controls a virtual object, and the object touches an avatar, a representation of the contact can be transmitted to the haptic device so that the user perceives that the object touched the avatar. If the avatar's movements or interactions constrain the object, such as by holding onto the object or if the object is inserted into an avatar, then the movements of the haptic device can be constrained to represent the virtual constraint. A user controlling the hand of an avatar, for example, where the avatar's hand touches a virtual object, can feel that touch interaction. A user controlling the movement of an avatar can feel environment forces between the avatar and its environment.

An example embodiment of the present invention includes interactions between users, where the users have avatar representations of themselves. Virtual forces or interactions between an avatar and its environment can be felt by a user through algorithms that simulate that sense of touch. For example, if two users are controlling the hands of their avatars, and the avatars shake hands, the users can feel forces representing shaking hands. This type of interaction can create a perception between the users that they feel what their avatar feels. If a first user controls the hand of a first avatar, and the hand touches the body of a second avatar controlled by a second user, then the first user can feel a force representing the hand touching the body, and the second user can feel a force representing being touched by the hand.

Multiple haptic devices can be used by users interacting with avatars. If a user utilizes multiple haptic devices, the devices can have different purposes in the interactions. For example, two haptic devices can be used to control each of an avatar's hands. A haptic device can be used to control an avatar's hand, while a separate haptic device can be used to control an avatar's movements. One haptic device can be used for interactions controlled by a user's hand, where the user manipulates the virtual environment, and a second haptic device can be used to create sensations, forces, and movements touching the user not on their hand. For example a user can control two haptic devices in a boxing simulator, where the haptic devices control the virtual boxer's hands. A haptic vest can be worn by the user which can create forces on the user simulating being punched by another user. Punches from a second user's avatar landing onto a first user's avatar, can create impact forces for the first user representing each punch as it is landed. A first user controlling a first avatar can control the avatar to perform a sexual act with a second avatar controlled by a second user. The first user can simulate the movement of his or her avatar in a sexual act by controlling a first haptic device, and the second user can feel those movements applied to his or her second avatar through a second haptic device. If a first user controls a first avatar who inserts a sexually stimulating device into a second avatar, then a second user controlling the second avatar can utilize a haptic device to move and insert a real sexually stimulating device in the same manner that the virtual interaction occurs. A user controlling an input representing the movement of a sexually stimulating device can control sexual interactions between avatars, where the sexual interactions are implemented in real life with real sexually stimulating devices controlled and moved by a haptic or robotic device. A medical doctor performing a medical procedure with an avatar representation of himself or herself, can control the avatar and simulate the medical procedure in the virtual world. The avatar's interactions with a virtual patient can be felt by the doctor through a haptic device. Students can feel the doctor's actions with their own haptic device as a learning tool. Students can watch the virtual procedure which is more realistic than it would otherwise be if the doctor did not have a sense of touch. The virtual interactions with a virtual patient can be implemented with a remote real patient and a robot that mirrors or simulates either the movements of the doctor or the doctor's avatar. Forces and data representing forces from either the patient's avatar interacting with virtual instruments or the real patient interacting with a robotic or haptic device equipped with sensors, can be sent back to the doctor's haptic device to create an accurate sense of touch related to or simulating the procedure.

Attachments and Accessories

The present invention includes haptic devices that have either an integrated interface to a user or a removable interface to a user, such as an end effector or other type of attachment that interacts with a user. Attachments can include, without limitation, end effectors a user holds onto, end effectors that are intended to interact with a user through movements and forces from a haptic device, medical instruments, end effectors that give users the ability to effectively create artistic works, end effectors that give users the ability to accurately position a cursor, end effectors designed to aid a user in a task, end effectors used to aid persons with physical or mental disabilities, end effectors designed to push against a part of a user other than a hand, or sexually stimulating devices that can touch a user, be inserted into a user, or be inserted over a user's body part. Attachments or the device itself can have sensors integrated into them that detect when the grip is being touched, is inserted into a human body (or a representation of a human body), or when a portion of a human body (or representation of a portion of a human body) is inserted into the grip. Sensor detection includes the sensing of concepts such as light, proximity, pressure, temperature, electrostatic, biometric, camera or any other available sensor technologies known to those skilled in the art. Information and data from sensors can alter the behavior, control, and feedback of a haptic device. For example, a 3D robotic device can have a needle end effector attachment. The needle can have a light sensor integrated into the tip of the needle. When a doctor telerobotically controls the needle and presses it into tissue, the light sensor can detect that the tip of the needle has entered the tissue. This state change can be sent to the doctor's haptic control device to update or modify the resistance and forces felt. This state change can also be incorporated with other information sent to the doctor's haptic device, such as force sensing information recorded by the device controlling the needle. The force sensing information can present a force to the doctor so that it feels to him as if he is directly controlling the needle and feeling when it is touching a patient. In the case of a sexually stimulating device, a light sensor, pressure sensor, movement sensor or any other type of sensor can detect if a device is engaged with a user, and the haptic interactions of a controlling device, telerobotically controlling a sexually stimulating device, can be adjusted.

An example embodiment of the present invention includes a first haptic device with a camera or microphone attached to it or to an end effector that moves when the haptic device moves. The haptic device can simply be a robotic device with no input control. The camera or microphone can be built into the device or end effector or can be attached externally. A light can also be attached or be built into the haptic device or end effector. A second haptic device can control the movement of the first haptic device. Haptic feedback can be sent from the first haptic device to the second haptic device. The first haptic device or its end effector can include the sensing of forces or position or can utilize other types of sensors in order to give haptic feedback to the second device. A user using the second haptic device can utilize the haptic feedback between the devices to get a sense of touch between the two devices, and the camera or the microphone can give the second user a sense of sight or hearing with the interactions.

An example embodiment of the present invention includes attaching a device designed for sexual stimulation to a robotic or haptic device, so that the sexual stimulating device moves. The sexual stimulating device can move relative to the user, can touch the user, can vibrate for the user, or can push on, around a body part, or inside the user. The sexual stimulating device can be a device without any electronics, such as a commercially available sex toy. A sexual stimulating device can include the ability to vibrate or move on its own, or vibrations or movement can come from the haptic device, or a combination of the two. The sexual stimulating device can be attached to a haptic device through an interface that makes it easily removable, and able to be easily reattached, so that multiple types of sexually stimulating devices can be used with a haptic device. An attachment to a haptic device can be a universal attachment that can be tightened around existing sex toys, so that the interface to the haptic device does not need to be integrated directly into the sex toy. A haptic device attachment mechanism for a sex toy can be integrated into the sex toy, so that it more easily attaches to a haptic device. An attachment to a sex toy, or wireless transmission, can transmit data about the state of the sex toy, the state of the user using the sex toy, the relation of the sex toy to the user, or any other information about the user or the sex toy. Data transmitted from a sex toy can be utilized to adjust movement and control of the haptic device. Sex toy attachments can have physical connectors built into their structure so that they can be easily attached to a haptic device, can be easily removed and cleaned, and can have a natural orientation when attached. A sexually stimulating device being moved by a haptic device can be controlled by other input devices specifically designed to represent sexual interactions. A first user's interactions with an input device that represents a human body part, can control a haptic device with a sex toy attached to it, where the sex toy interacts with a second user. The movements in relation to the input device can simulate the perceived interactions of the second user with his or her haptic device.

An example embodiment of the present invention includes a haptic device used by a first user that has a male or female sex toy attached to it. A second haptic device used by a second user can have a male or female sex toy attached to it. The two devices can communicate over a network, and can have haptic feedback and haptic data transmitted between them. Additional haptic devices can be used by either user, with sexually stimulating devices or with grips intended to be moved or controlled with a user's hand, where one device controls another either locally or remotely.

An example embodiment of the present invention includes an adapter for a haptic device that allows a physical device or component to be attached or detached from a haptic device. The end effector adapter can have a physical connector that connects to a haptic device, and an adjustable clamp in which a physical device or object is inserted and secured. The physical device can be secured to the adapter with a twist tightening, with a clamp latch mechanism, or other locking or securing mechanical mechanism. For example a plastic adapter can be manufactured with an end effector attachment on one end, and a circular clamp on the other end. A user can insert a cylindrical object into the circular clamp end of the adapter, and tightly secures the cylindrical object by clamping down a latch. The other end of the adapter can be inserted into a haptic device, therefore securing the cylindrical object to the haptic device. The mechanism can allow for movements or rotations relative to the haptic device. An adaptor to a haptic device can also have a component that plugs into the haptic device and means for another device to plug into it, including through an external clamping mechanism or a connector built into an object intended to be secured to a haptic device. An adaptor to a haptic device can also consist of a mechanical connection to existing end effectors for the haptic device. For example, if a haptic device has a standard sphere shaped end effector, an adaptor can consist of a mechanical interface to that sphere shaped end effector, which mechanically attaches to the sphere shaped end effector, and which allows other devices or adaptors to be connected to it. Mechanical interfaces for objects that are intended to be connected to a haptic device can be implemented such that the mechanical interface is part of the object or the object's design, and the interface can be used to connect directly with the haptic device or with an adaptor.

An example embodiment of the present invention includes a modification to a haptic device to account for the weight of an end effector. For example, if a heavy end effector is attached to a haptic device, the device can utilize its force and movement capabilities to account for the weight of the end effector. However, by doing so, a haptic device can lose some of its ability to generate adequate forces. Therefore, there can be a need to create an adjustment to the haptic device in order to account for an end effector's weight, particularly when there is a mechanism for interchangeable end effectors. A haptic device can utilize springs, additional motors, tensioning or torsioning mechanical structures, counter weights, or utilize other techniques known to those skilled in the art, to adjust the haptic device's movements or forces to account for an end effector. For example, in a haptic device that utilizes motors, a rotational spring that creates a rotational force on the motor can be added to the motor or a capstan attached to the motor, so that the pull or push on the motor balances against the weight of an end effector transmitted to the motor. A haptic device with 3 arms, for example, can have a spring attached to each arm, pushing or pulling as needed, to account for all or a portion of the weight of the end effector. Forces exerted by the motors can therefore be more efficiently used to move the end effector rather than simply hold it up.

Adjustments to the haptic device's movement structure can be external or internal. For example, springs can be applied internally within a haptic device to account for an end effector's weight, or a separate mechanism can be attached to a haptic device with external springs or mechanical structures which attach to the end effector in order to apply forces to it or support its weight. For example, a mechanical structure can be attached to a haptic device that includes springs that pull on an end effector or a mechanical structure influencing an end effector, so that the weight of the end effector is balanced against the forces from the springs.

Forces utilized to account for an end effector attached to a mechanical device can adjust the ways that an end effector moves rather than account for its weight. For example, in a situation where an end effector should have the ability to create a large upward force, the end effector can be mechanically influenced so that it can move upwards easily. The control of the haptic device can pull the end effector down until the desired upward action should be implemented at which point the combination of the motors controlling the device, for example, and the mechanical influence combine to create an upwards force that is stronger than possible with the motors alone. This can be true even if an end effector is attached, in which case the mechanical influence can account for both the desired effect and use of the system and the weight of the end effector.

Example embodiments of the present invention include bases that hold or stabilize a haptic device. A base can be a free standing base that a haptic device attaches to or sits on, or a base can be a part of a haptic device. A base can adjust a haptic device or a haptic device's workspace. For example, a base can be adjustable in height, position, or orientation. Bases can be utilized in conjunction with other features of haptic devices. For example, a base that adjusts the orientation of a haptic device can be used in conjunction with an end effector mechanism that adjusts the angle of an end effector. For example, if a base is adjusted so that it is angled downwards, and the device is therefore angled downward and its workspace is therefore lowered, an end effector interface can be adjusted so that an end effector is rotated so that it maintains an upward orientation within the adjusted workspace.

An example embodiment of the present invention includes a base with 3 or more legs that hold a haptic device securely, with an adjustable height. A base can have 3 legs such as a tripod, or 4 legs such as a table. It can be collapsible for storage. It can adjust orientation in addition to height. Orientation modifications can be implemented, for example, with a connection that loosens and tightens, allowing orientation movements when desired and not allowing orientation movements when not desired.

An example embodiment of the present invention includes an extension from a haptic device to an end effector. The extension can be a lever arm or other means of moving or adjusting the device's workspace relative to the device and haptic characteristics within the workspace. An extension can be attached to a haptic device on one end and an end effector can be attached to the other end of the extension. The extension can adjust the way that a haptic device moves and interacts with an end effector. For example, an extension that moves through a pivot point can reverse the direction a haptic device needs to move, to move an end effector attached to the other end of the extension. An extension that moves through a pivot point can adjust the amount of force needed to move an end effector or can adjust the movement range of an end effector. The weight of an extension on either side of a pivot point or weight attached or added to an extension on either side of a pivot point, can affect the control of an end effector. For example, the weight of an extension (or added weight to the extension) on the side of the pivot point near the haptic device can counter the weight of the end effector, which will allow forces on the haptic device to be used for moving the end effector rather than lifting it and moving it. An extension can be attached to a haptic device or end effector to allow or restrict various types of movement. For example, an extension can be a rod attached to a haptic device through a ball joint to allow 3 Degree Of Freedom (DOF) rotational movement of the rod relative to the haptic device. An extension can be a metal bar attached to 2 hinge mechanisms to allow only 2 DOF movement of the extension relative to the haptic device. An extension can also be a mechanical system such as a pulley system, a pivot point system, or geared system to allow forces applied by the haptic device to the extender to affect the end effector differently than if the end effector was directly attached for the haptic device. For example, a geared mechanical system used as an extender can allow the haptic device to create larger forces on a user touching an end effector attached to the end of the geared extender, than would be possible if the end effector was directly attached to the haptic device.

An extension can rest on or be attached to an object designed to work as a pivot point. The pivot-point-object (PPO) can allow smooth movement of the extension relative to the PPO in any direction or in certain directions. For example, a PPO can only allow movement of an end effector towards or away from the haptic device, can allow 3 Degree Of Freedom (DOF) movement in x, y, and z Cartesian space but not allow rotations for an end effector, can allow 3DOF translational movement and 2 degrees of freedom rotational movement for an end effector, can allow 6 DOF rotational and translational movement of an end effector, or can enable any other combination of degrees of freedom of movement of the extension or of an end effector. A PPO can be a device that sits on a table, sits on a specially designed base, or in any other way is grounded to enable the force and movement transmission. For example, a PPO can be a simple base that an extension rests on with sides to keep the extension from slipping off. An end effect can comprise a base with adjustable legs holding it up, a mechanical structure with bearings and a gimbal rotating mechanism to enable smooth movements, translations, and rotations of an end effector relative to a haptic device.

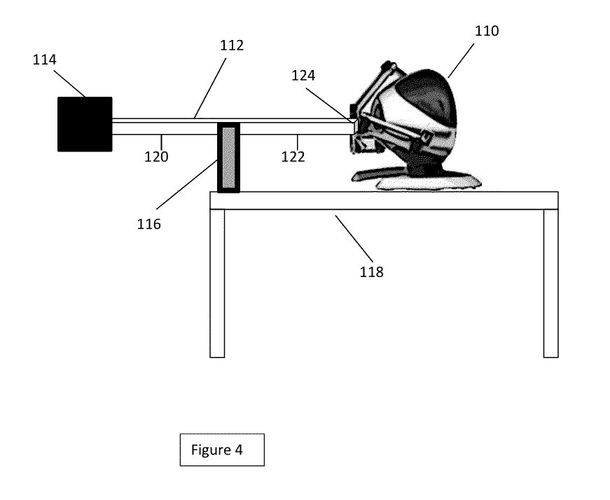

An example embodiment of the present invention is shown in FIG. 4. Haptic device 110 is attached to an extension 112 at attach point 124. Extension 112 is attached to an end effector 114. The extension 112 is attached to or resting on a pivot point object (PPO) 116 located relative to the haptic device such that the distance from the pivot point to the haptic device is the length of the portion of the extension 122 and the distance from the pivot point to the end effector is the length of the portion of the extension 120. The haptic device and PPO are resting on a surface such as a table 118. The PPO can also have its own structure so that it can rest on the floor, have an adjustable height, be moved around within a user's room or environment, or generally be positioned relative to the haptic device. The PPO can include a mechanism to keep movement smooth such as lubrication or ball bearings. The PPO can have a mechanical structure that only allows movements of the extension in certain degrees of freedom. For example, it can constrain rotations of the extension so that it cannot rotate about its long axis. In this example embodiment, the workspace for the end effector is located further away from the haptic device than if the end effector was directly attached to the haptic device. The haptic device components can move so that attachment point 124 moves up and down and the end effector moves down and up, respectively. The haptic device components can move so that attachment point 124 moves right and left and the end effector moves left and right, respectively. Attachment point 124 can move forwards and backwards relative to the haptic device, moving the end effector forwards and backwards. Software or algorithm modifications can adjust for the correct movement of the end effector relative to the haptic device compared to a situation where it is directly attached and not moving through a pivot point. Attachment point 124 can consist of two hinge joints or other similar structure that prevents the extension 112 from rotating around its long axis. The haptic device 110 can be raised up with a stand, and the work space of the end effector can therefore be lowered relative to the table 118. The attachment from the end effector to the extension can be implemented with a mechanism that loosens and tightens so that it can be rotated relative to the extension. Weight can be added to extension 112 on the portion near the base 122 with an external weight or by simply making the material in 122 bulkier or heavier compared to the material 120. If a weight is added to extension 112, the weight can be designed so that it attaches at various points on extension 112, to adjust for different end effectors. For example, a heavier end effector can be counterbalanced by a weight that is moved further from the pivot point 116, and then moved closer to the pivot point when a lighter end effector is attached. Adding weight to the extension in this way can compensate for the weight of the end effector making less strain on motors in a haptic device, for example. Adjusting the PPO 116 relative the haptic device 110, and therefore the distances of 120 and 122 can modify the system to tradeoff between workspace volume for the end effector and maximum forces that can be applied by the end effector.

Lengths of the arms relative to pivot point can adjust how the haptic device accounts for weight of the end effector, workspace size, and workspace location. The attachment to the haptic device can be a ball joint, or two hinge joints, for example. A device can be raised above a desk to lower the effective workspace below the height of the table.

An example embodiment of the present invention includes inputs from a mobile phone or tablet or other device with a touch screen. Movements of a finger across a touch sensitive screen, such as the iPhone or iPad, can be used to control a haptic device. For example, a movement up and down across a screen can move a haptic device or robot up and down. A movement right and left across a screen can move a haptic device or robot up and down. The inputs on a touch screen can be used to interact with a computer system controlling a haptic device or generally as a human computer interface for any type of interaction.

The movements of a finger on a touch screen can control a two dimensional cursor. A two dimensional cursor can be moved to push a button, resize or close a window, or start an application. Currently, movements of a finger on a touch screen can be used to directly touch a button, but movements of a 2D cursor and a subsequent indication of button press event can also be used to implement the same button press action. For example, in an operating system such as Windows 7, most of the interactions with the operating system were designed to be used with a mouse, touchpad, or similar controlling device which controls a 2D cursor. Windows 7 can also be used with computational devices or computers that have a touch screen. When Windows 7 is implemented with a touch screen interface and a 2D cursor control input device is not used with the computer, the interface can be difficult to use. Directly touching an icon on a small screen can be difficult. A touchscreen itself can be used to control a 2D cursor utilized with an operating system where the touch screen is part of a device that has the operating system installed on it. Movement of a finger from right to left or left to right can move a 2D cursor from right to left or left to right. Movement of a finger from top to bottom or bottom to top can move a 2D cursor down or up. Movements can be scaled to produce either finer control or larger movements. Movements on the touch screen to control a cursor's movements can happen anywhere on the screen that accepts touch input, and does not need to be where the cursor is currently located. A tap on the touch screen can indicate a left-mouse-click action. The tap can be anywhere on the screen and does not need to be where the cursor is currently located. A double tap on the touch screen can indicate a double click event, and the double tap does not need to occur where the 2D cursor appears on the screen. A user can press and hold a finger on the screen to indicate a right mouse click event. The press and hold does not need to occur where the cursor appears on the screen. Gestures, velocity tracking, pressure tracking, acceleration tracking, proximity tracking, multiple finger touch events, multiple finger touch and move events, or other types of finger touch tracking can indicate events in the system. It is natural to touch the specific area on a screen where you would like an action to be taken based on icons, graphics, and representation on the screen, but this method of interaction allows more precise control of actions, as the 2D controls do not need to be precise and can happen anywhere on the screen.

The present invention has been described as set forth herein in relation to various example embodiments and design considerations. It will be understood by someone of ordinary skill in the art that the above description is merely illustrative of the applications of the principles of the present invention. Other variants, combinations, equivalents and modifications of the invention will be apparent to those of skill in the art. The invention should therefore not be limited by the above described embodiments, methods, and examples, but by all embodiments and methods and combinations of embodiments and methods within the scope and spirit of the invention.

We claim:

1. A force communication system for use with a video communications system (VCS), wherein a first user views or is viewed on video communicated by the VCS, comprising:
(a) a haptic device configured to communicate motion, force, or a combination thereof, with the first user; and
(b) a haptic server system, configured to receive information from the VCS pertaining to a video connection between the VCS and the first user and to generate haptic commands for the haptic device corresponding to the video being communicated by the VCS.

2. A haptic communications system for use with a video communications system (VCS), wherein the VCS is configured to communicate a video representation of a first user to a second user, comprising a haptics communication system, configured to communicate information concerning force, motion, or a combination thereof from one user to the other, and configured to accept from the VCS information concerning communication with the first and second users, and configured to accept from the VCS information concerning initialization of the haptic communications system, and configured to communicate haptic information from one user to the other in parallel with the VCS.

3. A force communication system as in claim 2, further comprising a haptic device accessible to at least one of the first user and the second user, and wherein the haptic device is in communication with the haptic communication system.

4. A force communication system as in claim 3, further comprising a second haptic device accessible to the other of the first and second user and in communication with the haptic communication system.

5. A force communication system as in claim 3, further comprising a video acquisition device mounted with the haptic device such that motion of the haptic device or a portion thereof, causes corresponding motion of the video capture device.

6. A force communication system as in claim 5, wherein the video capture device is in communication with the VCS.

7. A force communication system as in claim 5, where the video capture device is in communication with the haptics communication system.

8. A force communication system as in claim 3, further comprising a non-haptic input device accessible to at least one of the first user and the second user, and wherein the non-haptic communication device is in communication with the haptics communication system.

9. A force communication system as in claim 2, further comprising one or more force sensors in communication with at least one of the first user and the second user, wherein the one or more force sensors communicate force information to the haptics communication system.

10. A force communication system as in claim 3, wherein the VCS is configured to communicate with a plurality of users, and further comprising a plurality of haptic devices, wherein each user has accessible at least one haptic device, and wherein the haptics communication system provides information to control a subset of the plurality of haptic devices responsive to control by a user controlling inputs to the haptics communication system.

11. A force communication system as in claim 3, wherein the VCS communicates information to the haptics communication system relating to a valid session.

12. A force communication system as in claim 3, wherein the haptics communication system controls robotic interactions between the two users, including allowing or denying said interaction.

13. A communications system comprising a haptic device, a video capture device mounted with the haptic device, wherein the haptic device and video capture device are accessible to a first user, and wherein a communication facility configured to communicate information from the video capture device and the haptic device using a computer network to a second user located remotely from the first user.

14. A communications system as in claim 13, wherein the haptic device comprises one or more handles detachably mounted with the haptic device.

15. A force communication system as in claim 2, wherein the haptic device comprises one or more handles detachably mounted with the haptic device.

16. A force communication system as in claim 4, wherein the first haptic device comprises one or more force sensors, and wherein force, motion, or both of the second haptic device is controlled responsive to signals from the one or more force sensors.

17. A force communication system as in claim 4, wherein the first haptic device comprises a state sensor, and wherein force, motion, or both of the second haptic device is controlled responsive to signals from state sensor.
